(19) United States
(12) Patent Application Publication
(10) Pub. No.: US 2003/0217100 A1
(43) Pub. Date: Nov. 20, 2003

(54) System and method for controlling environment maintenance equipment

(76) Inventor: David E. Kronk, Hilliard, OH (US)

Correspondence Address: STANDLEY & GILCREST LLP, 495 METRO PLACE SOUTH, SUITE 210, DUBLIN, OH, 43017, US

(21) Appl. No.: 09/506,676

(22) Filed: Feb. 17, 2000

(51) Int. Cl. G06F 15/16

(52) U.S. Cl. 709/203; 709/208

(57) ABSTRACT

The present invention is a system and method, based on an open, client-server architecture, for monitoring and managing environment maintenance equipment. Distributed, custom controls handle interactions with the devices such as sprinklers, pumpstations, and weather stations that may comprise the environment maintenance system. Messaging controls at a client and an interface control server facilitate communications between devices using text messages that are delivered, preferably, using the TCP/IP protocol of the Internet. System control and data acquisition controls allow for reading and writing of values for various settings and parameters on each device. Site managers in different domains provide directory services so that the messaging controls distributed throughout a system may located for communications. Using the present invention, remote clients or user interfaces such as telephones, personal computers, and personal digital assistants may be used to control environment maintenance devices that may be distributed throughout different domains.

### BACKGROUND AND SUMMARY OF THE INVENTION

The present invention relates generally to a system and method for controlling environment maintenance equipment and more particularly, to a system and method for interfacing of external software systems with automatic environment maintenance equipment.

Automatic environment maintenance systems are used for controlling various outdoor environments such as golf courses and ski runs. These outdoor environment maintenance systems may be comprised of many pieces of equipment such as irrigation sprinklers and controllers, weather stations, constant pressure pumpstations, compressor stations, water supply pumpstations, sewage controllers, snow guns and controllers, mowers, chair lifts, snow grooming vehicles, etc. Each component may be comprised of one or more electronic or mechanical devices that control various functions related to operation of the equipment maintenance system. For example, pumpstations may be comprised of multiple pumps, motors, valves, piping instrumentation, controls, and switchgear integrated and operating together to provide variable water flow at constant pressure to irrigation sprinkler heads or snowmaking guns. The pumpstation may further be adapted to collect and analyze data related to water flow, water pressure, pump cycling, pump hours, and alarms. Various devices connected to a weather station may be used to measure temperature, relative humidity, wind speed, wind direction, barometric pressure, soil temperature, lightning strikes, rainfall, or snowfall. Weather data from these devices may be important in setting values for other controls on the equipment that comprises the environment maintenance system.

Software systems for controlling certain components of environment maintenance systems are known. Typically, these software systems rely on physical, serial port connections between software modules and a particular set of devices. The software modules are implemented using procedure calls and serial port reads to access data needed by the software. Each one of the various software modules may control a particular device or a subset of devices. For example, at a golf course, irrigation control software may be used to control one set of devices while pumping station management software may be used to control another set of devices. For a ski resort, different software modules may control pumpstations, snowguns, lifts, grooming vehicles, and weather stations. There is no mechanism for integrating the separate software packages because the devices are “incompatible” and require different user interfaces. Consequently, a user must learn to use each software package that controls a device or set of devices.

Using current methods for developing environment maintenance systems, when a device is modified, modifications to the corresponding software module are required to take advantage of the additional functionality in the device. When a system device is added, an entirely new software module may be implemented to control the new device. It may further be necessary to add a new serial port for interfacing the software module and device. As each new device requires an additional physical connection and software module for controlling the device, expanding the system to include additional features and functionality is time-consuming and cumbersome.

Disparities in the operation of various pieces of equipment make it difficult for personnel to manage an outdoor environment. Different systems that may comprise many pieces of equipment are typically operated independently from one to the next with the same management personnel responsible for their operation. At major ski resorts, these systems can be spread out over many square miles of alpine terrain with substantial investment needed in labor and vehicles to monitor and maintain them on a daily basis. Consequently, there is a need for an environment maintenance system that supports seamless communication with the equipment that comprises the system.

The present invention overcomes many of the disadvantages in current automated environment maintenance equipment systems. The present invention is a system and method for monitoring and managing environment maintenance equipment devices that is based on an open, client-server architecture. The present invention is a modular system that takes advantage of current technologies and primarily, Internet technologies. In a preferred embodiment of the present invention, distributed, custom controls handle interactions with the devices that comprise the environment maintenance equipment system. These controls may be used to create an application or may be referenced from within HTML pages to create custom web browser interfaces to various devices. Using the present invention, integrated environment equipment maintenance systems may be developed for golf course applications, for ski resort applications, for other recreational areas, or for any application involving monitoring and managing of an outdoor environment.

The controls of the present invention communicate with each other using a common messaging control. In a preferred embodiment of the invention, a messaging control sends and receives asynchronous, text messages via the web standard TCP/IP protocol. Messaging over direct/dial-up serial port connections may be handled via a separate COMM to TCP/IP routing control. Due to the distributed nature of TCP/IP, the various system devices need not be located on the same machine to interact or function. The system devices or equipment may be on other machines on a LAN or out on the Internet.

In the present invention, clients or user interfaces make requests to servers as well as peer clients for information and receive responses via text messages. The text messaging feature of the present invention provides a loosely coupled client-server or peer-to-peer system of components. Consequently, it is easy to separate and rearrange the devices of the system to create different configurations for different applications. In a preferred embodiment of the present invention, using the TCP/IP backbone of the Internet and Intranets for sending the text messages allows system devices to be very distributed. Distributing components decreases the need to have numerous physical connections and other resources on a single computer. The messaging control features of the present invention provide a transparent way of multiplexing access to otherwise dedicated physical device connections.

The architecture of the present invention allows devices to be controlled from remote locations. Because control is based on text messaging, any remote device that supports text messaging may be used to control the devices of an environment maintenance system. For example, personal computers, touch-screen computers, telephones, radios, personal digital assistants, etc. may be used to send text messages that control the irrigation system devices. Users of the present invention are not restricted to using a particular brand or type of remote device. More importantly, once software with the messaging control of the present invention is installed on their remote devices, they need not change or upgrade the software to continue communicating with equipment located at a golf course, a ski resort, etc. Because the present invention is based on Internet technology, a remote device equipped with a web browser and messaging control may be used to control the devices of an environment maintenance system. Another benefit of the text messaging feature of the present invention is that the system devices may change or new ones may be added without requiring changes to the client or user interface software at the remote device. A user of the present invention may simply send to the device a new or different message using the existing client or user interface software. As a result, upgrading and updating systems may be accomplished very easily by simply adding the new or modified device to the network. The present invention is suitable for use in recreational outdoor areas such as golf courses and ski resorts and is suitable for use in other outdoor areas where control of grounds is important.

### BRIEF DESCRIPTION OF THE DRAWINGS

FIG. 1 is a schematic diagram of an architecture for an exemplary irrigation system for a preferred embodiment of the present invention;

FIG. 2 is a screen shot of a messaging control property screen for a preferred embodiment of the present invention;

FIG. 3 is a screen shot of a messaging terminal screen for a preferred embodiment of the present invention;

FIG. 4 is a screen shot of a send message screen and a screen shot of a receive message screen for a preferred embodiment of the present invention;

FIGS. 5 and 6 are screen shots for a site manager component for a preferred embodiment of the present invention;

FIG. 7 is a screen shot for a station controller component for a preferred embodiment of the present invention;

FIG. 8 is a screen shot of a control component for a preferred embodiment of the present invention; and

FIG. 9 is a screen shot of a messaging control referenced from within a web page for a preferred embodiment of the present invention.

### DETAILED DESCRIPTION OF PREFERRED EMBODIMENT(S)

The present invention is a system and method for monitoring and managing environment maintenance equipment based on an open, client-server architecture that takes advantage of Internet technologies. In a preferred embodiment of the present invention, distributed, custom controls handle interactions with the devices that comprise the system. These controls may be used to create an application or may be referenced from within HTML pages to create custom web browser interfaces to various devices. The devices that may be controlled include weather stations, mowing machines, irrigation systems, and pumpstations as may be used on a golf course. The devices that may be controlled also include chair and surface lifts, grooming vehicles, weather stations, lift ticket sales and tracking systems, snowmaking machines, water supply, and sewage systems as may be used at a ski resort. Any device that supports maintenance of an outdoor environment may be controlled in accordance with the Internet based client-server architecture of the present invention. Controlling operations may include receiving data from a device and sending commands to a device. In many cases, commands are issued to devices in response to data received from devices. This bi-directional communication allows for fine-tuning of equipment to meet changing outdoor conditions, failures in equipment, etc.

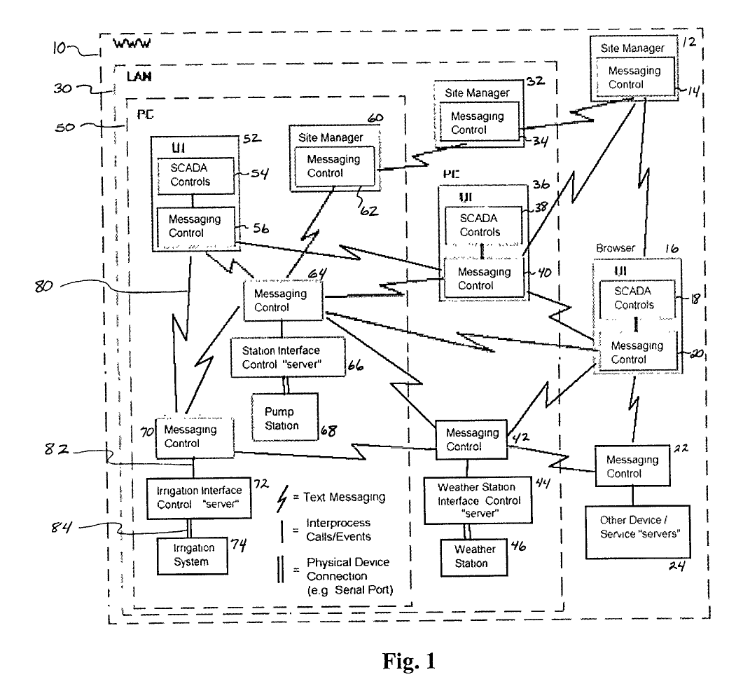

Referring to FIG. 1, a preferred embodiment of the present invention for a golf course application is shown. It is understood that the golf course application is merely exemplary. As shown in FIG. 1, various types of devices used for maintenance of a golf course may be supported using the present invention. An irrigation system 74, a pumpstation 68, and a weather station 46 may be controlled using the system and method of the present invention. As further shown in FIG. 1, each device or set of devices that comprise the system has an interface control server that controls the individual device or set of devices. Irrigation system 74 has an irrigation interface control server 72, pumpstation 68 has a station interface control server 66, and weather station 44 has a weather station interface control server 46. Other device/service servers 24 may be controlled using the present invention. As shown in FIG. 1, the connections between the servers and stations or systems are physical, serial port connections. For example, the connection 84 between the irrigation system 74 and irrigation interface control server 72 may be one or more serial port connections. The station interface control server 66 and pumpstation 68 as well as weather station interface control server 44 and weather station 46 also connect through a serial port.

The various servers (irrigation interface control server 72, station interface control server 66, weather station interface control server 44 and other servers 24) and therefore, connected devices (irrigation system 74, pumpstation 68, weather station 46) may be controlled through one client or user interface. As shown in FIG. 1, a user interface or client may be operational in different domains. For example, a worldwide web (WWW) domain 10, a local area network (LAN) domain 30, and a PC domain 50, may be supported. A PC domain user interface 52 may operate at the PC domain 50, a LAN domain user interface 36 may operate at the LAN domain 30, and a WWW domain user interface 16 may operate at the WWW domain 10. As also shown in FIG. 1, the user interfaces may be applications 52, 36 or browser interfaces 16. Any combination of user interface applications and browsers may be used in a system in accordance with the present invention.

Preferably, system control and data acquisition (SCADA) controls at each user interface 54, 38, 18 (whether an application 52, 36 or a browser 16), are used to interact with the interface control servers 72, 66, 44, 24. Each SCADA control may be used to set certain values or parameters for a device or to acquire data for further analysis. For example, a SCADA control 54 in the PC domain 50 may be used for interfacing to the irrigation interface control server 72, station interface control server 66, or weather station interface control server 46. As shown in FIG. 1, messaging controls at the user interface clients and the interface control servers support interfacing between remote devices and the maintenance devices of the system which may be distributed throughout the domains. At the user interface 52 in the PC domain 50, a messaging control 56 supports communications with other messaging controls. For example, messaging control 56 may be used for communications with the messaging control 70 of the irrigation interface control server 72, the messaging control 64 of the station interface control server 66, and a messaging control 40 associated with the user interface 36 of the LAN domain 30. A messaging control may communicate with any other messaging control in the system. Therefore, a messaging control 56 in the user interface 52 of the PC domain 50 may communicate with a messaging control 42 of a weather station interface control server 44 in the LAN domain through a messaging control 64 at a station interface control server 66. Commands for controlling each of the equipment maintenance devices may be sent from user interface clients to interface control servers using the messaging controls at the clients and servers.

Preferably, a site manager is present in each domain to serve as an address directory so that the various messaging controls can find each other. As shown for the embodiment of the present invention in FIG. 1, the WWW domain 10 has a site manager 12, the LAN domain has a site manager 32, and the PC domain 50 has a site manager 60. A messaging control is associated with each of the site managers in the domains. As shown in FIG. 1, the site manager 60 in the PC domain 50 has a messaging control 62, the site manager 32 in the LAN domain 30 has a messaging control 34, and the site manager 12 in the WWW domain 10 has a messaging control 14.

Text messages may be exchanged between the various messaging controls 56, 62, 64, 70 34, 40, 42, 14, 20, 22 to accomplish communications with or commands to the environment maintenance devices. For example, a text message 80 may be exchanged between the messaging control 56 of the user interface 52 in the PC domain 50 and the messaging control 70 of the irrigation interface control server 72 to control an aspect of the irrigation system 74. Although text messages are used between messaging controls, communications between the messaging control 70 and the irrigation interface control server 72 may be accomplished using known interprocess calls/events techniques 82. Similar interprocess calls/events techniques may be used for communications between the messaging controls 70, 42 and interface controls servers 72, 44 for the irrigation system 74 and the weather station 46.

The embodiment of FIG. 1 is merely representative of the types of environment maintenance system configurations that may be supported using the present invention. It is understood that the irrigation interface control server 72, station interface control server 66, weather station interface control server 44, and other device/service servers 24 may each be located in a different domain. Furthermore, interface control servers may be added to or removed from a particular system configuration. Because the present invention relies on messaging controls and text messages for communications in accordance with Internet standards, the number of possible system configurations is not limited in any way. Servers that are adapted to communicate in accordance with messaging controls may receive requests and respond by communicating commands to the specific devices that they control. Environment maintenance equipment that operates in accordance with varied and incompatible protocols and that may be provided by different vendors may still be controlled through the present invention.

The toolkit of the present invention is based on controls that allow the interfacing between external software systems that may be used to operate devices on, for example, an irrigation system, a pumpstation, or a weather station. Preferably, the toolkit is a collection of custom (Active-X/OCX) controls that handle the various station SCADA interactions between devices. In a preferred embodiment of the present invention, a messaging control integrated directly into an interface control server or a client handles the inter-software communications using sockets. Preferably, the controls are compatible with the Windows 95, 98, and NT operating systems.

The controls of the present invention may be used to create an application or may be referenced from within HTML pages, preferably, using Javascript to create custom web browser interfaces. The various SCADA controls 54, 38, 18 communicate with each other using common messaging controls. The messaging controls send and receive asynchronous text messages via the web standard TCP/IP protocol. Messaging over direct or dial-up serial port connections (as may be required for specific equipment) may be handled via a separate COMM to TCP/IP routing control.

Preferably, the messaging controls 56, 62, 64, 70, 34, 40, 42, 14, 20, 22 encrypt text messages before sending and decrypt them upon receipt. Also, a username and password may be a part of the various text messages sent between messaging controls to prevent unauthorized access. These security features provide assurance that only authorized users are controlling equipment from distant locations.

In a preferred embodiment of the present invention, the message controls function like a mailbox. A message control sends text messages to destination addresses as well as queues incoming messages. The message controls support bi-directional communications so that information may be retrieved from devices as well as sent to devices. Messages may be any text string of up to 4K characters in size. Preferably, clients and servers wishing to communicate in accordance with the messaging controls agree upon a query/response syntax. Listings of sample commands/syntax for a pumpstation site manager and a pumpstation controller are provided in Appendices A and B. A listing of sample commands/syntax for a weather station is provided in Appendix C.

A particular query or request message may require additional text or parameters such as a security token generated from User/Password information. Preferably, a standard delimiter used by the various messages. For example, the pipe “|” symbol may be used as a standard delimiter.

To help a client match a particular response to an original request, a standard parameter that may be used for most messages is a message identifier tag. The request's ‘mid=’ tag may be given a unique value which is returned in the response's ‘rid=’ tag so that the two can be matched up.

The following is a sample text message that may be used to request a pumpstation's downstream pressure:

FTXGET|name=DnStrm PSI|sec=2147483648|mid=m1056

If the station interface control server receiving this message validates the security token (‘sec=’) value, it may respond with a text message containing “FTXSUCCESS” and the PSI value:

FTXSUCCESS|value=120|rid=m1056

If a message identifier is not used, the response message, preferably, contains the original request text for identification purposes.

FTXGET|reg=N21:0|user=developer|pwd=pump log 2000

FTXSUCCESS|value=120

If the security information is invalid (or the request fails for some other reason), a “FTXFAILED” message may be returned with a comment. For example, the following message may be returned:

FTXFAILED|comment=Not Authorized for the Message Type

Preferably, the various message fields need not be in any particular order and any additional tags or values that are not part of a request's normal syntax are simply treated as comments and are ignored.

If a particular message contains no recognizable request, the message may be ignored completely although a response message, which contains the original message for identification reasons, may still be sent. For example, if the request is as follows:

What time is it?

FTXUNKNOWN|comment=Message is of unknown type . . .

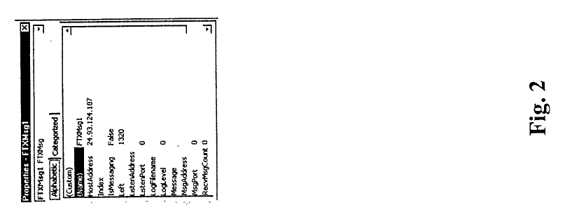

Referring to FIG. 2, a screen shot of a messaging control properties screen for a preferred embodiment of the present invention is shown. Preferably, the messaging control has the following properties and methods.

Properties:

| | |
|---|---|
| HostAddress | (Read Only) String listing the default TCP/IP address for the host machine |
| IsMessaging | (Read Only) Boolean which indicates if the control is currently messaging (i.e., the |
| | StartMessages( ) method has been called). |
| ListenAddress | String giving the address to listen for incoming TCP/IP messages on. This is left |
| | selectable vs. set automatically to HostAddress because a host may have multiple LAN cards (and |
| | thus multiple TCP/IP addresses). |
| ListenPort | Number giving the port to listen for incoming TCP/IP messages on. The following are valid |
| | values: |
| | 0—Selects any available port |
| | 1 through 5000—Considered “reserved” for “standard” TCP/IP protocols (e.g. FTP, HTTP, etc.) |
| | 5001 through 65534—Typical port number range for the messaging controls |
| | 65535—Don't listen for incoming messages . . . (Control will still send messages) |
| LogFilename | String giving text file name to receive logging of select control activity (for debugging |
| | purposes). Leave the filename blank to disable logging. |
| LogLevel | Number stating the types of activity to log: |
| | 0—Logs errors, warnings, and trace infonnation |
| | 1—Logs errors and warnings |
| | 2—Logs errors only |
| Message | String (of up to 4096 characters) which represents the current incoming/outgoing message. |
| MsgAddress | String listing the TCP/IP address of the current incoming/outgoing message. If the |
| | message is outgoing, this is the “send to” address. If the message is incoming, this is the “sent |
| | from” address. |
| MsgPort | Number listing the TCP/IP port of the current incoming/outgoing message. If the message is |
| | outgoing, this is the “send to” port. If the message is incoming, this is the “sent from” port. |
| RecvMsgCount | (Read Only) Number of received messages that are currently in the FIFO queue |
| | (retrieve each by calling RecvMessage( ) method). |
| Methods: | |
| FindCRC(someString) | Takes someString and computes a corresponding CRC-32 value and returns the |
| | resulting (long) number. Use this method to build security token (sec=) values for messages from |
| | the concatenation of ‘user=’ + ‘pwd=’ string values. |
| StartMessages( ) | Starts the control messaging using the current Listen Address: Port and logging settings. |
| | If successful, method returns TRUE, otherwise FALSE (and sets the IsMessaging property |
| | accordingly). |
| StopMessages( ) | Stops the control messaging (closes logging, flushes remaining queued incoming |
| | messages, and sets the IsMessaging property to FALSE). After stopping, new Listen Address: |
| | Port or logging settings can be specified and messaging restarted |
| OpenMessages( ) | Call to gain ownership of control (for synchronizing access from multiple threads). |
| | The call blocks if another Thread has already called OpenMessages( ) and has not yet released |
| | control via CloseMessages( ). If not successful (e.g. messaging not started), method returns |
| | FALSE, otherwise TRUE. |
| CloseMessages( ) | Call to release ownership of the control (for synchronizing access from multiple |
| | threads). Try to release the control as soon as possible to allow maximum usage. If not successful |
| | (e.g. messaging not started), method returns FALSE, otherwise TRUE. |
| SendMessage( ) | Sends the text in the Message property to the control listening at the given MsgAddress: |
| | MsgPort. If not successful (e.g. messaging not started or destination control not available), |
| | method returns FALSE, otherwise TRUE. |
| RecvMessage( ) | Retrieves the next incoming message from the control's incoming message queue and |
| | places the text into the Message property and the sender's address into the MsgAddress & |
| | MsgPort properties. The control automatically receives and queues incoming messages until this |
| | call retrieves them in FIFO order (or until memory is exhausted). If not successful (e.g. |
| | messaging not started or no queued messages), method returns FALSE, otherwise TRUE. |

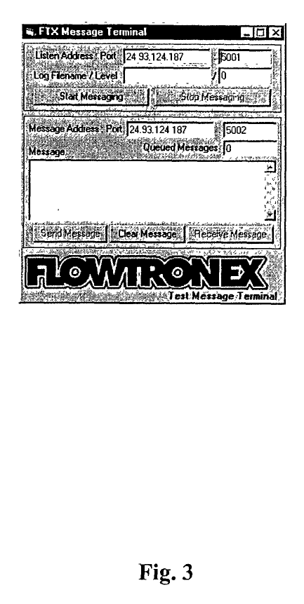

Referring to FIG. 3, preferably, a messaging terminal tool is provided to allow manual messaging for development testing, debugging, etc. Referring to FIG. 3, the Listen Address field may be filled automatically with a host's IP address. A user may choose an unused port number and click “Start Messaging” to turn on communications.

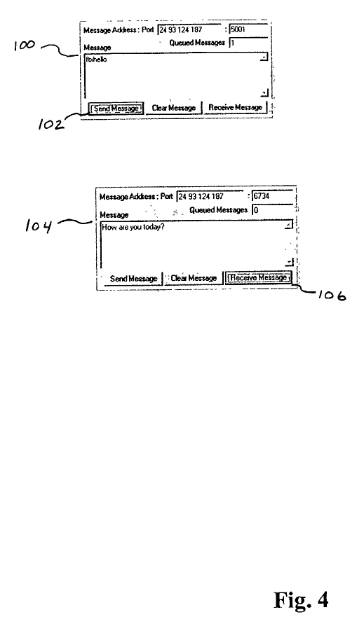

Referring to FIG. 4, screens for sending and receiving messages are shown. To send a message, in the send message screen 100, a user may enter a destination address and port as well as a desired message text. When ready, the user may click a Send Message button 102 to send the message.

To receive a message, in the receive message screen 104, a user may click the Receive Message button 106 to retrieve the next queued (FIFO) message. Preferably, the port and address fields are updated to show who sent the message.

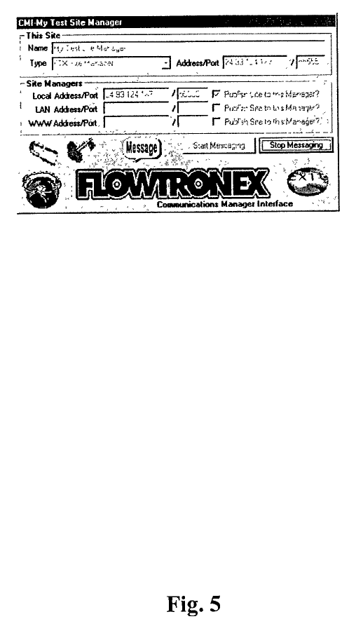

In a preferred embodiment of the present invention, a site manager is a directory service that allows sites to register their addresses so that other sites can find them and communicate, preferably via messaging controls. Referring to FIG. 5, a screen shot of a site manager user interface for a preferred embodiment of the present invention is shown. To use the site manager, a user may name a site (e.g., My Test Site Manager) and enter or select an identification Type (e.g., FTX Site Manager). Next, the user may specify a unique port to use for the site manager. The user may also specify the addresses of other site managers to register this manager. A user may start communications with other site managers by clicking a Start Messaging button to begin communications. A Stop Messaging button may be selected to close communications.

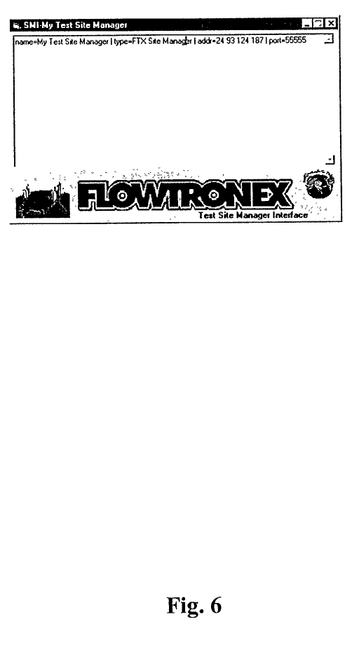

Referring to FIG. 6, a screen shot of a screen for sending text messages to other messaging controls is shown. As shown in FIG. 6, the main window reflects the site name and there is a new entry in the Site Manager (for itself). The site manager is now ready to accept client requests for registering and looking up site addresses. Appendix A has a listing of exemplary commands and syntax for a pump station.

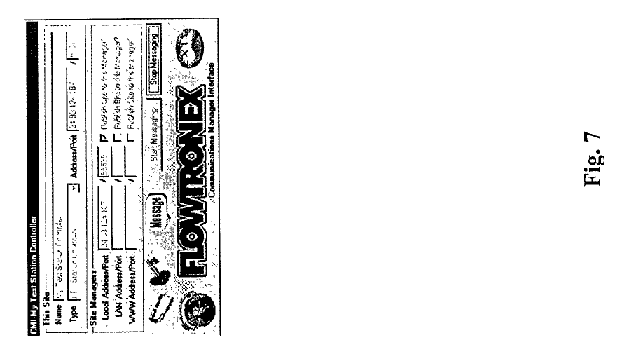

The present invention may be used to control many devices. For example, the present invention may be used to control a pumpstation. A station controller for a pumpstation is a component and related service that handles reading and writing information directly to a pumpstation. Referring to FIG. 7, a screen shot of a station controller interface for a preferred embodiment of the present invention is shown. To use the station controller, a user may name a station controller (e.g., My Test Station Controller) and enter or select an identification type (e.g., FTX Station Controller). Next, the user may specify a unique port to use for the station controller. The user may also specify the addresses of a site manager to register the station controller with a site manager. A user may start communications with other site managers by clicking a Start Messaging button to begin communications. A Stop Messaging button may be selected to close communications. Text messages may be entered in a separate window that reflects the site name. The station controller may then accept client requests for registering and looking up messaging control addresses. A listing of example commands and syntax for a pumpstation controller is provided in Appendix B. Other devices that comprise an environment maintenance system may be added in a similar manner. For example, irrigation systems, weather stations, mowing machines, snowmaking machines, grooming vehicles, etc. may be added to a system.

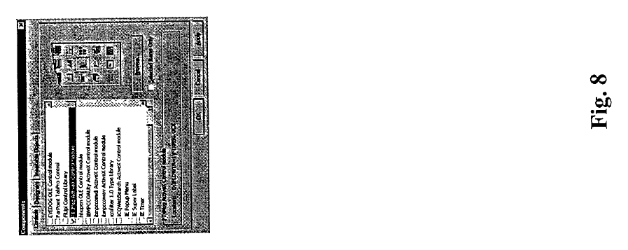

In a preferred embodiment of the present invention, ActiveX controls are used to implement the SCADA and messaging controls of the present invention. Microsoft's Visual Basic may be used to develop the controls. Referring to FIG. 8, a screen shot of a control component for a preferred embodiment of the present invention is shown. After the control is installed on a developer's workstation, it may be used from Visual Basic by adding it to the component toolbar by checking/enabling the listed example “FTXMsg ActiveX Control module” as shown in FIG. 8. Controls may be added for each device that comprises an environment maintenance system.

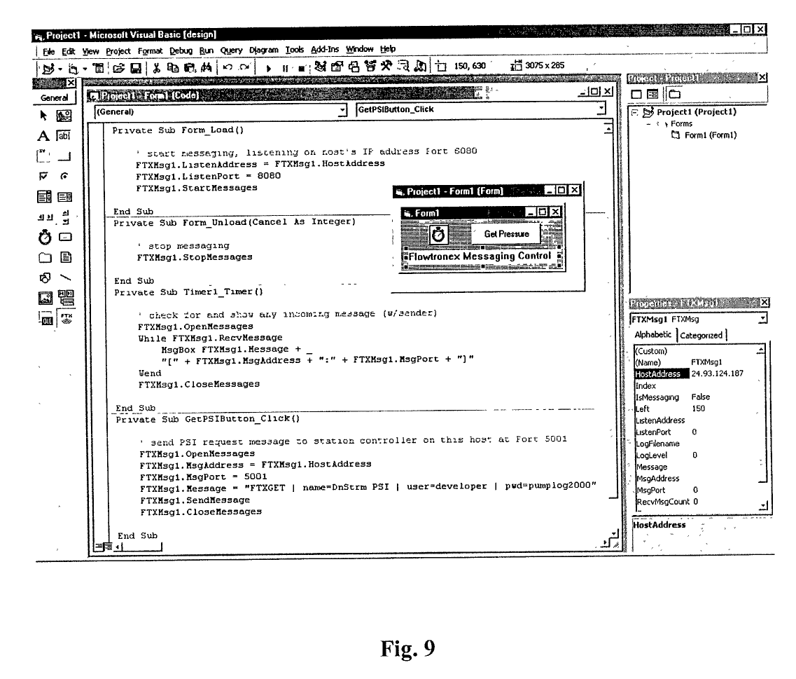

Referring to FIG. 9, a screen shot is shown for a simple Visual Basic project that uses the example FTXMsg control to retrieve the downstream PSI from a pumpstation controller running on the same host machine which is listening on TCP/IP port 5001. The messaging control (and other pumpstation SCADA controls) may also be referenced from within DHTML web pages to create customizable browser interfaces, for example, using Internet Explorer or Netscape w/ActiveX plug-ins.

When applied to a golf course application, the present invention may be used as follows. A golf course superintendent uses a lot of different equipment to accomplish his or her job. Examples of the equipment that may be used include a weather station, an irrigation system, a pumpstation, and mowing equipment. The ability to rapidly gather information from this equipment and make decisions based on this input is a key to the superintendent's success. Throughout the day, the superintendent may be in his office, on the golf course, at home, or on the road. Therefore, the ability to seamlessly communicate with his course provides him or her with a powerful tool.

Following are some examples of items that might typically be monitored and/or changed, wherever the superintendent is located. It is not meant as an exhaustive list, but simply as a typical list.

Weather—the superintendent may need to monitor wind speed, direction, temperature, and relative humidity in order to make decisions regarding settings for other pieces of equipment.

Mowing Equipment (GPS equipped)—the superintendent may need to know where the mowers are located on the golf course and who is working on the course.

Irrigation system—the superintendent may need to know whether the irrigation system is running. He or she may further need to know what the theoretical flow is and which irrigation program is running. In response to the information the superintendent receives, he or she may manually syringe greens or initiate (or stop) an irrigation program to be certain that the course is not harmed by any particular action.

Pumpstation—the superintendent may need to monitor pressure, flow, and alarms (low pressure, high pressure, pump fault, VFD fault). The superintendent may further need to know how much water was pumped during a particular time period. The superintendent may review pump run hours and review flow and pressure history to see if there is any erratic flow, pressure, or pump cycling scenarios that could indicate a problem. The superintendent may also need to modify setpoint pressure, modify lockout times and days, enable fertigation as well as set up times for fertigation.

Pumpstation Diagnostics—the superintendent may also need remote diagnostics of pumpstation by factory service or technician. Through a web-based interface in accordance with the present invention, the superintendent, factory technician, and local technician may view the pumpstation diagnostics simultaneously and troubleshoot the problem. The pumpstation may be fine-tuned, including tuning the PID, start/stop parameters, and pump sequencing tables.

The present invention may assist a superintendent in accomplishing all of the above tasks. The ability to add and remove devices to an existing system without modifications to client or user interface software containing a messaging control allows a superintendent to quickly and easily monitor and manage environment maintenance equipment.

When applied to a ski resort application, the present invention may be used as follows. The ski industry is an equipment intensive business with substantial capitol investment required for the basic infrastructure of the average resort. This infrastructure may include some or all of the following categories:

chair lifts and surface lifts with logic based control and alarm systems;

grooming vehicles with GPS based tracking and computer controlled snow coverage management;

multiple weather stations with centralized recording and reporting;

computer managed lift ticket sales and tracking systems;

snowmaking pump and control systems with logic based control systems and centralized recording and reporting;

domestic water supply and sewage systems with logic based control systems; and

golf course irrigation systems with logic based control systems and centralized recording and reporting.

It is important for ski resort personnel to monitor and manage this equipment so the ski resort can continue to operate. The present invention allows ski area managers to receive the data they need. As these systems have become larger and more complex, it is important for ski area managers to receive a constant stream of real-time data from all this equipment so that they may effectively manage the resort. The present invention allows the managers to receive the data quickly so that decisions can be made earlier and more efficiently for such matters as the night grooming and snowmaking schedule if the skier traffic is up that morning. In another aspect, weather problems can be detected more quickly and problems with lifts can be responded to more efficiently. The present invention provides the capability to seamlessly interface management with these systems that use various protocols and hardware for the purpose of real time monitoring. The equipment of the ski resort may be interfaced to messaging controls in accordance with the present invention so that the operator is provided with multiple choices of how he or she would like to view and manipulate the data. For example, lifts, snow grooming, ticket sales, snowmaking and weather stations may be connected to messaging controls so an operator may view the data on a modem PC, LAN PC, laptop computer, personal digital assistant, or any PC with Internet access.

The present invention supports the development and expansion of environment maintenance systems that may be comprised of many pieces of equipment. By providing a messaging control for device communications, it is possible for various devices of an environment maintenance system (e.g., irrigation system, pumpstation, weather station, snowmaking machine, grooming vehicle, etc.) to easily interact using text messages. SCADA controls allow for reading and writing values for various settings and parameters on each device. Messaging controls facilitate the communications between the SCADA controls and the devices through interface control servers that provide direct communications (e.g., through physical device connections) with the various devices that may comprise a system. Messaging controls may further communicate with SCADA controls and interface server controls using interprocess calls/events. Site managers provide directory services so that the messaging controls distributed throughout a system may communicate. Using the present invention, remote clients or user interfaces may be used to control devices that may be distributed throughout different domains.

The preferred embodiments herein disclosed are not intended to be exhaustive or to unnecessarily limit the scope of the invention. The preferred embodiments were chosen and described in order to explain the principles of the present invention so that others skilled in the art may practice the invention. Although the examples provided herein relate to control of environments in recreational areas, the present invention may be used for control of any outdoor environment. Having shown and described preferred embodiments of the present invention, those skilled in the art will realize that many variations and modifications may be made to affect the described invention. Many of those variations and modifications will provide the same result and fall within the spirit of the claimed invention.

[image]

[image]

[image]

[image]

[image]

[image]

[image]

What is claimed is:

1. A system for controlling environment maintenance equipment comprising:
a plurality of interface control servers for controlling environment maintenance devices;
a client for communicating with said interface control servers; and
a messaging control at said client and at each of said plurality of interface control servers for exchanging messages between said client and each of said plurality of interface control servers.

2. The system of claim 1 wherein environment maintenance devices are selected from the group consisting of irrigation sprinklers and controllers, weather stations, constant pressure pumpstations, compressor stations, water supply pumpstations, sewage controllers, snow guns and controllers, mowers, chair lifts, and snow grooming vehicles.

3. The system of claim 1 wherein said client is operational at a device selected from the group consisting of personal computers, laptop computers, touch-screen computers, telephones, radios, and personal digital assistants.

4. The system of claim 1 wherein messages exchanged between said client and each of said plurality of interface control servers are text messages.

5. The system of claim 1 further comprising a system control and data acquisition control at said client for interacting with said interface control servers.

6. The system of claim 1 wherein messages are exchanged between said messaging controls in accordance with TCP/IP protocol.

7. The system of claim 1 further comprising a site manager for registering said messaging controls.

8. The system of claim 1 wherein said client and said interface control server operate in different domains.

9. A method for controlling environment maintenance equipment comprising the steps of:
connecting an interface control server to an environment maintenance device;
installing a first message control at said interface control server;
installing a second message control at a client;
entering a message at said client;
communicating said message from said client to said interface control server in accordance with said first message control and said second message control; and
controlling said environment maintenance device at said interface control server in accordance with said message.

10. The method of claim 9 wherein said environment maintenance device is selected from the group consisting of irrigation sprinklers and controllers, weather stations, constant pressure pumpstations, compressor stations, water supply pumpstations, sewage controllers, snow guns and controllers, mowers, chair lifts, and snow grooming vehicles.

11. The method of claim 9 wherein said client is operational at a device selected from the group consisting of personal computers, laptop computers, touch-screen computers, telephones, radios, and personal digital assistants.

12. The method of claim 9 wherein said message exchanged between said client and said interface control server is a text message.

13. The method of claim 9 further comprising the step of installing a system control and data acquisition control at said client for interacting with said interface control server.

14. The method of claim 9 wherein said message is exchanged between said first and second messaging control in accordance with TCP/IP protocol.

15. The method of claim 9 further comprising the step of registering said first and second message controls with a site manager.

16. The method of claim 8 wherein said interface control server is in a first domain and said client is in a second domain.

17. An apparatus for controlling an environment maintenance device, comprising:
an interface control server adapted for communication with said environment maintenance device;
a messaging control at said interface control server for receiving messages from a client; and
a connection between said interface control server and said environment maintenance device, said connection adapted for communicating a command to said environment maintenance device in accordance with a message from said client.

18. The apparatus of claim 17 wherein said environment maintenance device is selected from the group consisting of irrigation sprinklers and controllers, weather stations, constant pressure pumpstations, compressor stations, water supply pumpstations, sewage controllers, snow guns and controllers, mowers, chair lifts, and snow grooming vehicles.

19. The apparatus of claim 17 wherein said message received at said interface control server is a text message.

20. The apparatus of claim 17 wherein said message received at said interface control server is received in accordance with TCP/IP protocol.
